(19) United States
(12) Patent Application Publication
(10) Pub. No.: US 2024/0164497 A1
(43) Pub. Date: May 23, 2024

(54) PROTECTIVE CASE FOR MOBILE DEVICE AND MANUFACTURING METHOD THEREOF

(71) Applicant: Shenzhen Guangyipeng Technology Co., Ltd, Shenzhen (CN)

(72) Inventor: Jie Weng, Shenzhen (CN)

(21) Appl. No.: 18/084,575

(22) Filed: Dec. 20, 2022

(30) Foreign Application Priority Data
Nov. 17, 2022 (CN) 202211440621.2

(51) Int. Cl. A45C 11/00; B32B 1/00; B32B 7/12; B32B 17/10; B32B 27/36

(52) U.S. Cl. CPC A45C 11/00; B32B 1/00; B32B 7/12; B32B 17/10018; B32B 17/10302; B32B 17/10779; B32B 17/10807; B32B 27/36; B32B 2457/00

(57) ABSTRACT

A protective case for mobile device includes a bottom case and a top case. The top case includes a protective case frame and a protective film. The protective case frame includes a side wall and a flange. The protective film includes a first explosion-proof film, a first adhesive disposed on a front surface of the first explosion-proof film, and a tempered glass fixed to the front surface of the first explosion-proof film by the first adhesive. The periphery of the first explosion-proof film exceeds the periphery of the tempered glass and the periphery of the first adhesive to form a protruding periphery, and the front surface of the protruding periphery is provided with a second adhesive to adhere to the back surface of the flange of the protective case frame.

### CROSS REFERENCE

The present application claims priority of Chinese Patent Application No. 202211440621.2, filed on Nov. 17, 2022, the entire contents of which are hereby incorporated by reference.

### TECHNICAL FIELD

The present application belongs to the technical field of mobile device accessories, and in particular, to a protective case for mobile device and a manufacturing method thereof.

### DESCRIPTION OF THE PRIOR ART

With the development of smart phone, the protective case for mobile device has become one of the common accessories. In order to protect the mobile screen from scratching, some protective cases for mobile device are provided with a transparent protective film. However the wear resistance of such transparent protective film is not ideal. Although some protective films have a tempered glass, the tempered glass is directly adhered to the protective case frame. When the mobile device falls, the protective case frame may be collided and the tempered glass is easily broken. In addition, a gap is formed between that tempered glass and the protective case frame, after dust and foreign matters enter into the gap, they are easy to adhere to the protective film and are not easy to be removed, affecting the overall aesthetic appearance of the mobile device.

### SUMMARY OF THE DISCLOSURE

The purpose of the embodiments of the present application is to provide a protective case for mobile device with a tempered glass that is shatterproof, has good dampening performance and is suitable for long-term use.

For the above objective, the technical solution adopted by the present application is to provide a protective case for mobile device, comprising a bottom case and a top case which are detachably connected with each other, and the top case includes:
a protective case frame comprising a side wall and a flange extending from an inner wall surface of the side wall; and
a protective film comprising a first explosion-proof film, a first adhesive provided on a front surface of the first explosion-proof film, and a tempered glass fixed to the front surface of the first explosion-proof film by the first adhesive, wherein the first explosion-proof film has a profile fit with a profile of the flange, sizes of the tempered glass and the first adhesive are smaller than a size of the first explosion-proof film, and a periphery of the first explosion-proof film forms a protruding periphery beyond peripheries of the tempered glass and the first adhesive;
wherein a front surface of the protruding periphery is provided with a second adhesive which is adhered to a back surface of the flange of the protective case frame, thereby fixing the protective film with the protective case frame

Compared with the prior art, in the protective case for mobile device according to the embodiments of the present application, the periphery of the first explosion-proof film has a protruding periphery extending beyond the peripheries of the tempered glass and the first adhesive. After the protruding periphery is adhered and fixed to the flange of the protective case frame by the second adhesive, the protective film and the protective case frame which are separate pieces can be fixed, with cushion therebetween. The tempered glass is not easy to be broken, with an improved dampening performance. As there is no adhesive on the area of the front surface of the protruding periphery corresponding to the gap between the flange and the tempered glass, dust and foreign matters would not be adhered to the front surface of the first explosion-proof film. Even if dust and foreign matters enter the gap between the flange and the tempered glass, the dust and foreign matters can be easily removed from the gap, facilitating the removal of the dust and foreign matters for long-term use.

### BRIEF DESCRIPTION OF DRAWINGS

In order to make the technical solutions in the embodiments of the present application apparent, the drawings which are referred to in the description of the embodiments or the prior art will be briefly described below. Obviously, the drawings only refer to a few embodiments of the present application. For those skilled in the art, other drawings can be obtained on the basis of these drawing without the effort of creative labor.

FIG. 1 is a perspective view of a protective case for mobile device according to an embodiment of the present application;

FIG. 2 is a perspective view of the protective case for mobile device of FIG. 1 with a mobile device installed therein, wherein the support is in a folded state;

FIG. 3 is an exploded view of the protective case for mobile device shown in FIG. 2;

FIG. 4 is a perspective view of the protective case for mobile device of FIG. 1 with the mobile device installed therein, wherein the support is in an unfolded state;

FIG. 5 is a front view of the protective case for mobile device shown in FIG. 2;

FIG. 6 is a cross sectional view in FIG. 5 along the direction AA;

FIG. 7 is an enlarged view of part B in FIG. 6;

FIG. 8 is an enlarged view of part C in FIG. 6;

FIG. 9 is an exploded view of a top case of the protective case for mobile device shown in FIG. 1;

FIG. 10 is a perspective view of a protective film of the protective case for mobile device of FIG. 1;

FIG. 11 is an enlarged partial cross-sectional view of a protective case for mobile device according to another embodiment of the present application;

FIG. 12 is a flowchart of a method for manufacturing a protective case for mobile device according to an embodiment of the present application;

FIG. 13 is a partial flowchart of a method for manufacturing the protective case for mobile device shown in FIG. 12;

FIG. 14 is a schematic view of a manufacturing process of a protective film;

FIG. 15 is a partial flowchart of a method for manufacturing the protective case for mobile device shown in FIG. 12;

FIG. 16 is a schematic view of a manufacturing process of a protective film;

FIG. 17 is a partial sectional view of a protective case for mobile device according to a comparative example; and

FIG. 18 is a schematic view of a manufacturing process of a protective film of the protective case for mobile device shown in FIG. 17.

### DESCRIPTION OF EMBODIMENTS

In order to make the technical problems to be solved, technical solutions and advantages of the present application more apparently, the present application will be further described in detail with reference to the drawings and embodiments. It should be understood that the specific embodiments described herein are merely illustrative of the application and are not intended to limit the application.

It should be noted that when an element is said to be “fixed” or “arranged” on another element, it may be directly “fixed” or “arranged” on the other element or indirectly “fixed” or “arranged” on the other element. When an element is said to be “connected” to another element, it may be directly “connected” to the other element or indirectly “connected” to the other element.

It should be understood that, terms such as “length”, “width”, “up”, “down”, “front”, “back”, “left”, “right”, “vertical”, “horizontal”, “top”, “bottom”, “inner”, and “outer” refer to the orientations or positional relationships shown in the drawings, which is for ease of description of the present application and simplification of the description, rather than indicating or implying that the device or element referred to must have a particular orientation, or be constructed and operated in a particular orientation, and therefore should not be construed as limiting of the present application.

In addition, terms “first” and “second” are used for descriptive purpose only and are not to be understood as indicating or implying the relative importance or implicitly indicating the number of technical features referred to. Thus, a feature defined with “first” or “second” may explicitly or implicitly includes one or more of such features. In the description of this application, “multiple” means two or more unless otherwise specified.

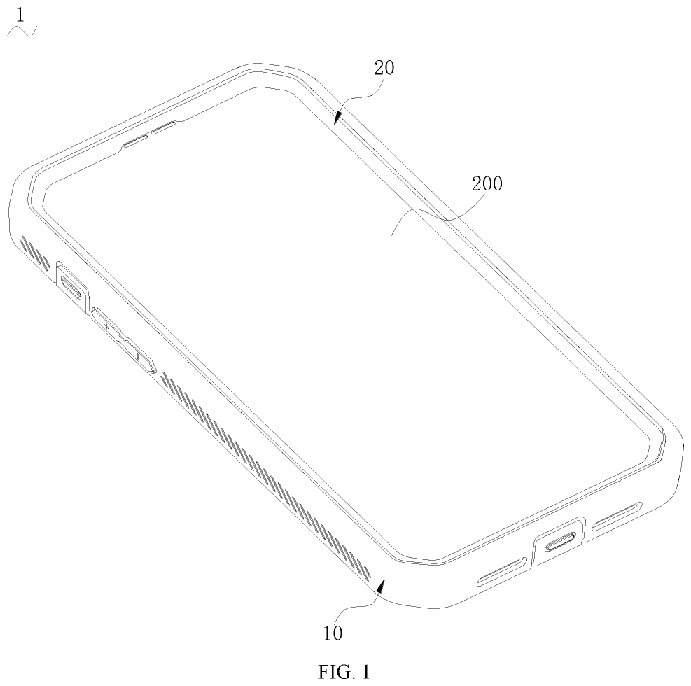

Referring to FIG. 1 to FIG. 3, a protective case for mobile device 1 according to an embodiment of the present application will be described. The protective case for mobile device 1 includes a bottom case 10 and a top case 20. The top case 20 and the bottom case 10 are detachably connected with each other. Specifically, the top case 20 can be assembled to the bottom case 10 by snap-fitting. When the top case 20 is assembled to the bottom case 10, the top case 20 and the bottom case 10 enclose a receiving space for receiving the mobile device 2. In use, the mobile device 2 can be first placed in the bottom case 10, and then the top case 20 can be snapped into the bottom case 10 to fix the mobile device 2, so as to protect the front, back and sides of the mobile device 2. To take the mobile device 2 out, remove the top case 20 from the bottom case 10, and then the mobile device 2 can be taken out from the bottom case 10. The bottom case 10 defines a camera hole 14 for exposing the camera of the mobile device.

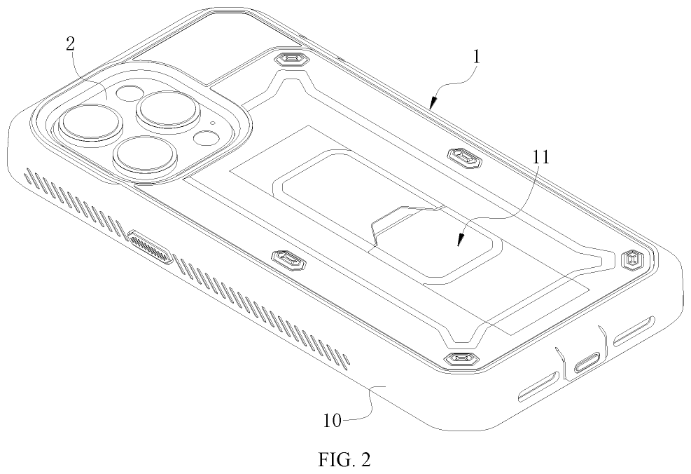

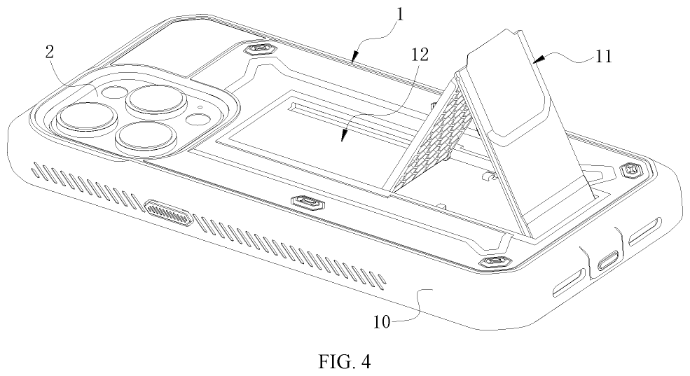

The back of the bottom case 10 is provided with a recess 12 in which a support 11 that can be folded and unfolded is arranged. As shown in FIG. 2, the support 11 is folded, and the support 11 is received in the recess 12. As shown in FIG. 4, the support 11 is in an unfolded state and can support the mobile device.

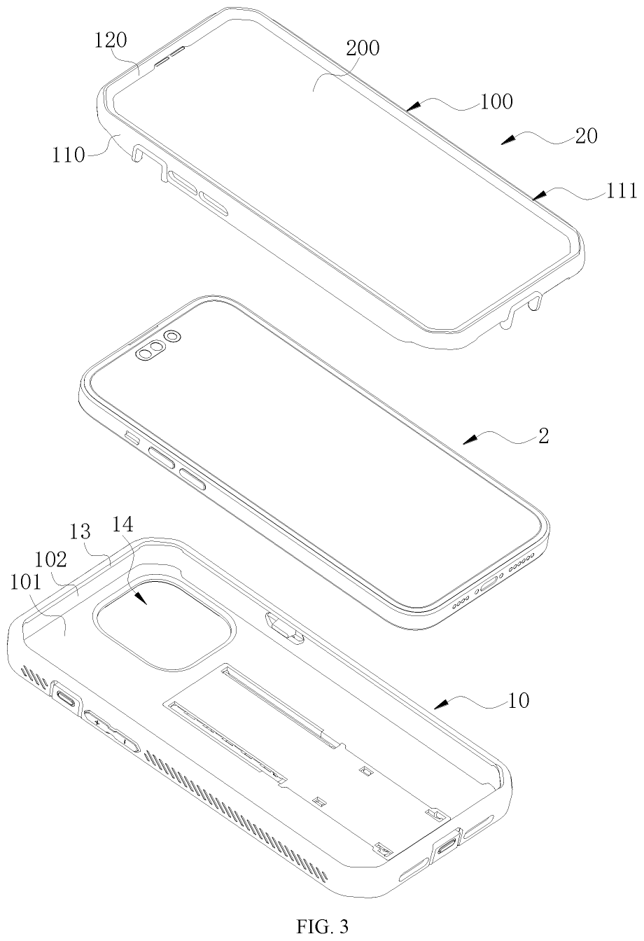

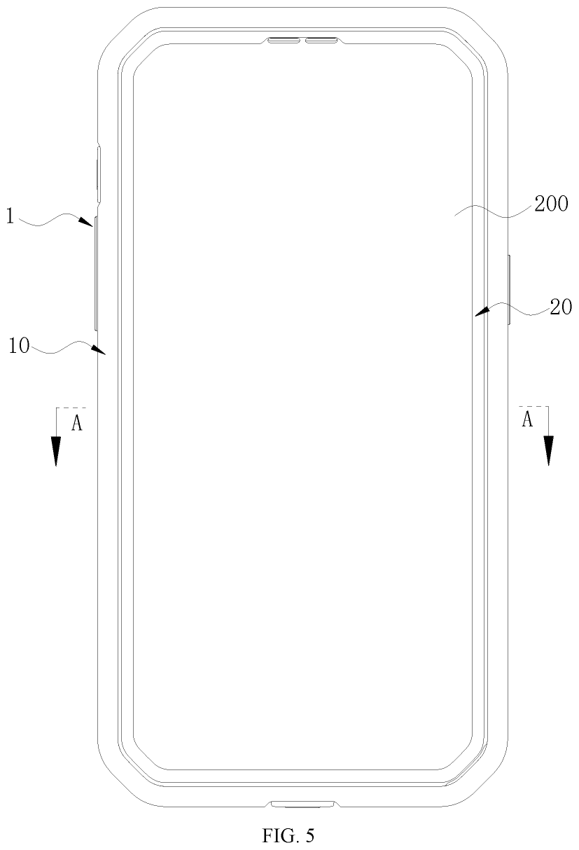

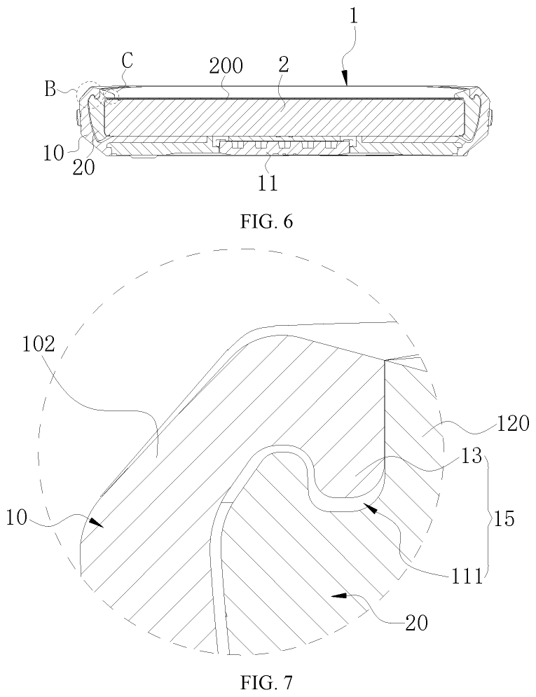

Referring to FIG. 3, FIG. 5 and FIG. 6, the top case 20 includes a protective case frame 100 and a protective film 200. The protective case frame 100 can be an injection molded part. The protective case frame 100 includes a side wall 110 and a flange 120. The flange 120 extends from the inner wall surface of the side wall 110 of the protective case frame 100. Preferably, the front surface of the flange 120 is flushed with the front surface of the protective case frame 100. The protective case frame 100, the protective film 200 and the bottom case 10 enclose a receiving space for receiving the mobile device 1.

Referring to FIGS. 3, 6 and 7, a snapping structure 15 is disposed between the bottom case 10 and the protective case frame 100, and the top case 20 is snapped with the bottom case 10 through the snapping structure 15. The snapping structure 15 includes a groove and a protrusion provided between the bottom case 10 and the protective case frame 100, and the top case 20 can be snapped to the bottom case 10 through the groove and the protrusion.

Specifically, in this embodiment, the snapping structure 15 includes a snapping slot 111 and a protruding rim 13. The front outer surface of the side wall 110 of the protective case frame 100 is provided with the snapping slot 111. The bottom case 10 includes a back plate 101 and a periphery edge 102 extending along the periphery of the back plate 101 at one side of the back plate 101. The front portion of the periphery edge 102 is provided with the protruding rim 13. Therefore, the top case 20 can be snap-fitted to the bottom case 10, thereby realizing the detachable connection of the top case 20 and the bottom case 10. By providing the snapping slot 111 in the front outer surface of the top case 20 and the protruding rim 13 on the bottom case 10, when connecting the mobile device 2 with the protective case for mobile device 1, the mobile device 2 is placed in the bottom case 10, then, the bottom case 10 with the mobile device 2 is snapped with the top case 20 so that the protruding rim 13 is snapped into the snapping slot 111 of the top case 20, thereby connecting the top case 20 and the bottom case 10. This snapping structure makes the assembling and disassembling between the top case 20 and the bottom case 10 convenient and fast.

Preferably, when the top case 20 is assembled to the bottom case 10, the front surface with the flange 120 of the protective case frame 100 and the front surface with the periphery edge 102 of the bottom case 10 are smooth so that no steps would be formed between the connection of the flange 120 and the periphery edge 102. After the top case 20 is assembled to the bottom case 10, the top case 20 is received in the bottom case 10, and the connection between the top case 20 and the bottom case 10 is smoothly transitioned, the protective case for mobile device 1 has an aesthetic appearance and comfortable user experience.

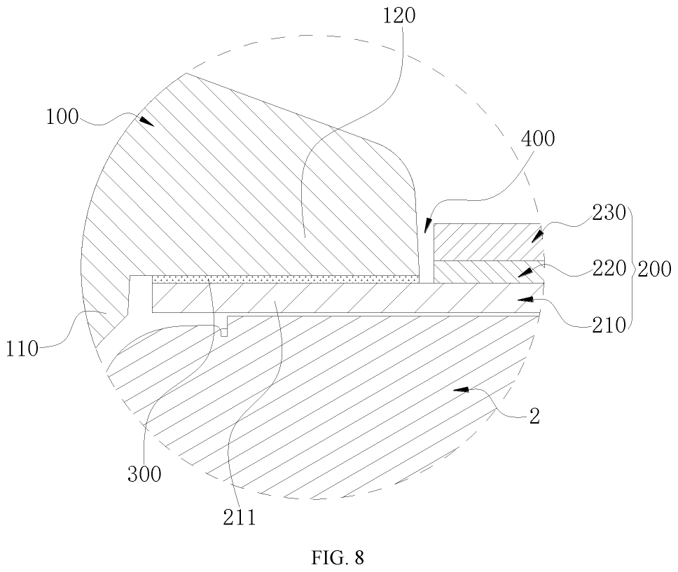

Further, referring to FIGS. 8-10, the protective film 200 includes a first explosion-proof film 210, a first adhesive 220, and a tempered glass 230. The first adhesive 220 is disposed on the front surface of the first explosion-proof film 210. The tempered glass 230 is fixed to the front surface of the first explosion-proof film 210 through the first adhesive 220. The profile of the first explosion-proof film 210 conforms with the profile of the flange 120. The first explosion-proof film 210 is substantially rectangular as a whole, and four corners thereof can be chamfered. The sizes of the tempered glass 230 and the first adhesive 220 are smaller than that of the first explosion-proof film 210 so that the periphery of the first explosion-proof film 210 is configured as a protruding periphery 211 beyond the peripheries of the tempered glass 230 and the first adhesive 220. A second adhesive 300 is disposed on the front surface of the protruding periphery 211. The protruding periphery 211 is adhered to the back surface of the flange 120 of the protective case frame 100 through the second adhesive 300, thereby fixing the protective film 200 with the protective case frame 100.

The protruding periphery 211 is provided so that the protective film and the protective case frame 100 are provided in separate pieces, with cushion therebetween, thereby improving the dampening performance, and thus the tempered glass 230 is shatterproof. The protruding periphery 211 is adhered to the flange 120 through the second adhesive 300. The front surface of the first explosion-proof film 210 corresponding to the gap 400 between the tempered glass 230 and the flange 120 would not be adhered with dust and foreign matters and is easy to be cleaned for long-term use. When the protective case for mobile device 1 is assembled with the mobile device, the screen of the mobile device is in contact with the back surface of the first explosion-proof film 210, such that the tempered glass 230 of the protective film 200 faces the user. When the user needs to operate the screen of the mobile device, the finger of the user contacts with the tempered glass 230, without in direct contact with the screen of the mobile device, and the protective film 200 protects the screen of the mobile device.

Compared with the prior art, the periphery of the first explosion-proof film 210 of the protective case for mobile device 1 according to the present application has a protruding periphery 211 beyond the peripheries of the tempered glass 230 and the first adhesive 220. After the protruding periphery 211 is adhered and fixed to the flange 120 of the protective case frame 100 by the second adhesive 300, the protective film 200 and the protective case frame 100 can be fixed, in which the protective film 200 and the protective case frame 100 are provided as separate pieces, with cushion therebetween, the tempered glass 230 is shatterproof, with an improved dampening performance. As there is no adhesive on the area of the front surface of the protruding periphery 211 corresponding to the gap 400 between the flange 120 and the tempered glass 230, dust and foreign matters would not be adhered to the front surface of the first explosion-proof film 210. Even if dust and foreign matters enter the gap 400 between the flange 120 and the tempered glass 230, the dust and foreign matters can be easily removed from the gap 400, facilitating the removal of the dust and foreign matters for long-term use.

Further, one or more layers of shock-proof materials can be covered around the protective case frame 100. Alternatively, the protective case frame 100 can be made of hard plastic and shock-proof materials in one piece to further improve the strength of the protective case frame 100 and enhance the protective performance.

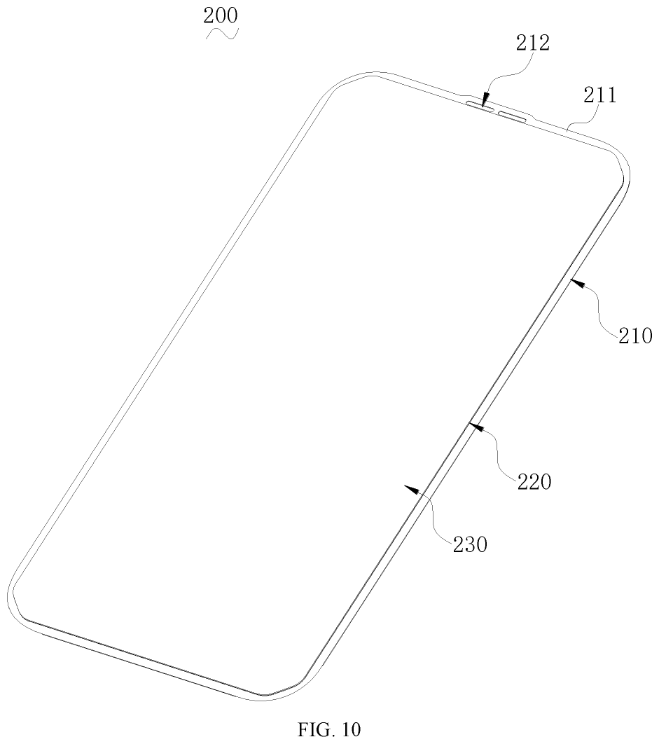

Referring to FIG. 10, the protruding periphery 211 defines two slots 212 corresponding to the positions of the speakers of the mobile device. Sound transmittable layers can be provided within the slots 212, and the sound transmittable layer has a plurality of sound transmittable holes.

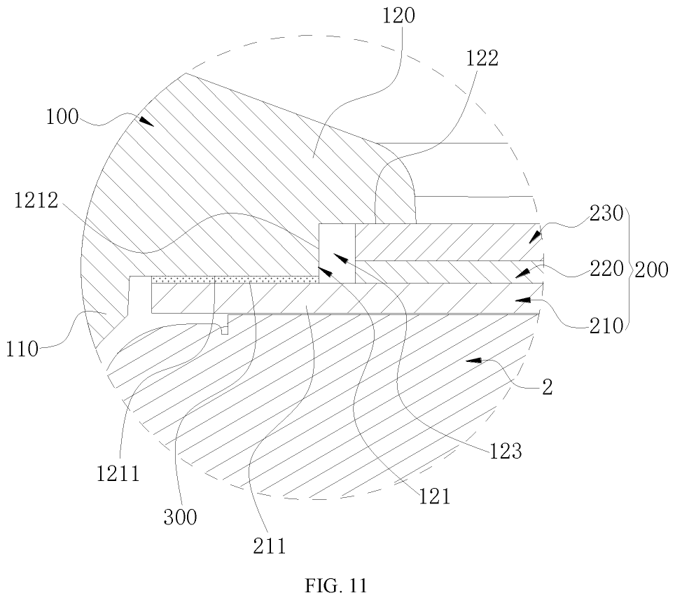

Referring to FIG. 11, in one embodiment, the back surface of the flange 120 is provided with a step 121. The step 121 includes a first step surface 1211 and a second step surface 1212 connected with each other. The first step surface 1211 and the second step surface 1212 are connected at a right angle or a substantially right angle. One end of the first step surface 1211 is connected to the side wall 110 of the protective case frame 100. The step 121 allows a shielding surface 122 to be formed on the back surface of the flange 120. The second step surface 1212 and the shielding surface 122 enclose an annular groove 123. The protruding periphery 211 is adhered to the first step surface 1211 by the second adhesive 300, and the periphery of the tempered glass 230 extends into the annular groove 123. That is, the peripheries of the tempered glass 230 and the first adhesive 220 are shielded by the shielding surface 122, and the peripheries of the tempered glass 230 and the first adhesive 220 are both located in the annular groove 123. Therefore, no gap 400 is formed between the side wall of the flange 120 of the protective case frame 100 and the tempered glass 230, with a more aesthetic overall appearance, and the protective case for mobile device 1 has a better dustproof performance.

Preferably, in this embodiment, there is a space between the tempered glass 230 and the second step surface 1212, so that the protective film 200 can be fixed to the protective case frame 100 more easily. That is, a certain error is allowed when fixing the protective film 200 to the protective case frame 100, and the requirement for the alignment the protective film 200 to the protective case frame 100 can be lowered, thereby reducing the processing difficulty of the protective case for mobile device 1.

Preferably, in this embodiment, the front surface of the tempered glass 230 abuts against the shielding surface 122. There is no gap 400 between the protective case frame 100 and the tempered glass 230, so that dust and foreign matters are less likely to enter between the tempered glass 230 and the protective case frame 100, thereby further improving the dustproof performance. That is, not only is the periphery of the tempered glass 230 hidden inside the flange 120, but also there is no gap 400 between the tempered glass 230 and the shielding surface 122, thereby preventing dust and foreign matters from depositing between the tempered glass 230 and the flange 120, avoiding the tedious operation of cleaning dust and foreign matters and facilitating a long-term use.

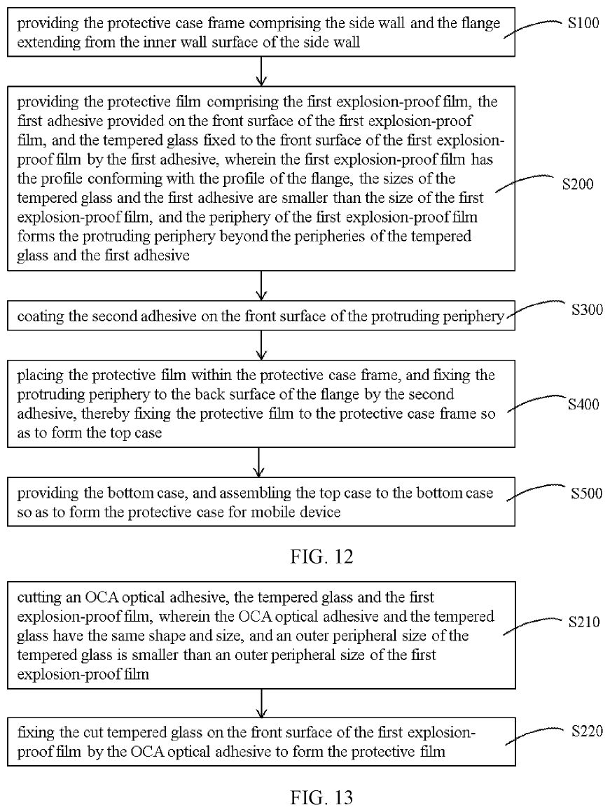

Referring to FIGS. 1, 8, 12 and 13, the manufacturing method of the protective case for mobile device 1 according to an embodiment of the present application includes the following steps:

In step S100, the protective case frame 100 is provided. The protective case frame 100 includes a side wall 110 and a flange 120. The flange 120 extends from an inner wall surface of the side wall 110.

In step S200, the protective film 200 is provided. The protective film 200 includes a first explosion-proof film 210, a first adhesive 220 disposed on the front surface of the first explosion-proof film 210, and a tempered glass 230 fixed on the front surface of the first explosion-proof film 210 by the first adhesive 220. The profile of the first explosion-proof film 210 conforms with the profile of the flange 120. The sizes of the tempered glass 230 and the first adhesive 220 are smaller than that of the first explosion-proof film 210. The periphery of the first explosion-proof film 210 has a protruding periphery 211 beyond the peripheries of the tempered glass 230 and the first adhesive 220.

In step S300, the second adhesive 300 is coated on the front surface of the protruding periphery 211. The width of the region where the protruding periphery 211 is coated with the second adhesive 300 can be equal to or slightly smaller than the width of the region where the protruding periphery 211 is pre-adhered and fixed to the flange 120. Alternatively, the second adhesive 300 can be coated on the back surface of the flange 120 of the protective case frame 100, or can be coated on both the back surface of the flange 120 of the protective case frame 100 and the front surface of the protruding periphery 211.

In step S400, the protective film 200 is placed within the protective case frame 100 so that the protruding periphery 211 is adhered and fixed to the back surface of the flange 120 by the second adhesive 300, thereby fixing the protective film 200 and the protective case frame 100 to form the top case 20. Specifically, align the center of the protective film 200 to that of the protective case frame 100, place the protective film 200 within the protective case frame 100, and fix the protruding periphery 211 of the first explosion-proof film 210 to the flange 120 by the second adhesive 300, thereby fixing the protective film 200 to the protective case frame 100.

In step S500, the bottom case 10 is provided, and the top case 20 is snapped into the bottom case 10 to form the protective case for mobile device 1.

In the manufacture method of the protective case for mobile device 1 according to the embodiment of the present application, the periphery of the first explosion-proof film 210 has a protruding periphery 211 beyond the peripheries of the tempered glass 230 and the first adhesive 220. The protruding periphery 211 is adhered and fixed to the flange 120 of the protective case frame 100 by the second adhesive 300 so as to fix the protective film 200 and the protective case frame 100 which are provided in separate pieces, with cushion therebetween, and the tempered glass 230 is shatterproof, with an improved dampening performance. As there is no adhesive on the area of the front surface of the protruding periphery 211 corresponding to the gap 400 between the flange 120 and the tempered glass 230, dust and foreign matters would not be adhered to the front surface of the first explosion-proof film 210. Even if dust and foreign matters enter the gap 400 between the flange 120 and the tempered glass 230, the dust and foreign matters can be easily removed from the gap 400. The dust and foreign matters can be easily removed for long-term use.

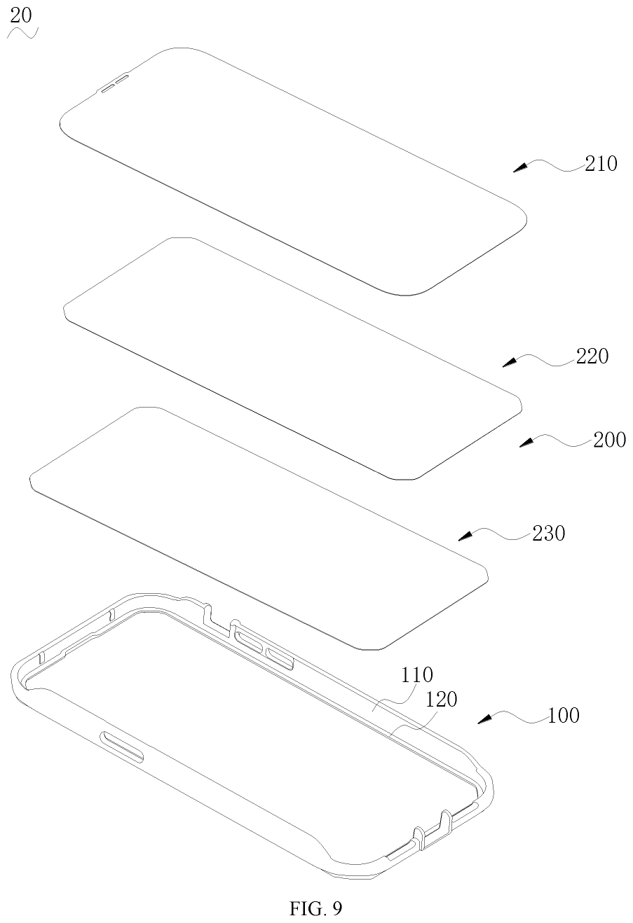

Referring to FIG. 3, FIG. 9, FIG. 13 and FIG. 14, specifically, the first adhesive 220 is OCA optical adhesive. The step of providing the protective film 200 includes:

In step S210, the OCA optical adhesive, the tempered glass 230 and the first explosion-proof film 210 are cut in sizes. The shape and size of the OCA optical adhesive are the same as that of the tempered glass 230. The cross section of the OCA optical adhesive is substantially rectangular, and the four corners of the OCA optical adhesive can be chamfered. The peripheral size of the tempered glass 230 is smaller than that of the first explosion-proof film 210. It will be appreciated that other highly transparent, double-sided adhesives can be used as alternatives of the OCA optical adhesive.

In step S220, the cut tempered glass 230 is fixed to the front surface of the first explosion-proof film 210 by the OCA optical adhesive to form the protective film 200. The side wall of the tempered glass 230 is flushed with the side wall of the OCA optical adhesive, and the periphery of the first explosion-proof film 210 extends beyond the peripheries of the tempered glass 230 and the first adhesive 220 to form the protruding periphery 211. That is, the OCA optical adhesive, the tempered glass 230, and the first explosion-proof film 210 of the protective film 200 are separated before the cutting, and after cutting, the tempered glass 230 is fixed to the first explosion-proof film 210 by the OCA optical adhesive. The protective film 200 provides the protruding periphery 211 for adhering with the flange 120, the front surface of which is not covered with the OCA optical adhesive, so that, in the resulted protective case for mobile device 1, the region of the first explosion-proof film 210 corresponding to the gap 400 between the tempered glass 230 and the flange 120 would not be adhered with dust and foreign matters, and the dust and foreign matters deposited in the gap 400 can be easily removed.

Preferably, in this embodiment, in step S300, the step of coating the second adhesive 300 on the front surface of the protruding periphery 211 is performed by dispensing. Specifically, the second adhesive 300 can be coated on the front surface of the protruding periphery 211 by a dispenser, which can improve the manufacturing efficiency of the protective case for mobile device 1.

Referring to FIGS. 3, 8 and 9, the inner periphery of the flange 120 of the protective case frame 100 defines an opening, and the outer periphery of the tempered glass 230 of the protective film 200 is smaller than or equal to the opening in size. It is to be understood that the peripheral size of the tempered glass 230 can be modified according to the specific structure of the flange 120. As shown in FIG. 11, the outer peripheral size of the tempered glass 230 cane be set larger than the size of the opening defined by the inner periphery of the flange 120, so that the periphery of the tempered glass 230 is hidden within the flange 120, so that dust and foreign matters are not easily introduced between the tempered glass 230 and the flange 120, avoiding cleaning operations for dust and foreign matters, and facilitating a long-term use.

Referring to FIG. 8, a space is defined between the edge of the tempered glass 230 and the flange 120 of the protective case frame 100. That is, after the protective film 200 is fixed to the protective case frame 100, a gap 400 is remained between the tempered glass 230 and the flange 120, without adhesive on the surface of the first explosion-proof film 210 corresponding to the gap 400. Thus, even if dust and foreign matters enter the gap 400, the dust and foreign matters can be easily removed from the gap 400, facilitating the removal of the dust and foreign matters.

Preferably, there is a space between the edge of the first explosion-proof film 210 and the side wall 110 of the protective case frame 100, so that the manufacturing difficulty of the protective case for mobile device 1 can be reduced.

In this embodiment, the material of the second adhesive 300 is different from the material of the first adhesive 220. The first adhesive 220 can be a double-sided adhesive with high light transparency, and the second adhesive 300 can be a material with high adhesive strength.

Preferably, in this embodiment, the first adhesive 220 is an OCA optical adhesive, the second adhesive 300 is glue, and the adhesive strength of the second adhesive 300 is set to be greater than the adhesive strength of the first adhesive 220. The OCA optical adhesive can be cured at room temperature or medium temperature, and has small curing shrinkage, with the characteristics of high light transparency (>99% of full light transmission rate), high adhesive strength, high weathering resistance, water resistance, high temperature resistance and ultraviolet resistance, without the problem of yellowing, peel and deterioration when used for a long time. The second adhesive 300 is glue, so that the first explosion-proof film 210 is stable after being adhered to the flange 120 of the protective case 100, and is not easily detached from the flange 120, facilitating the long-term use of the protective case for mobile device 1.

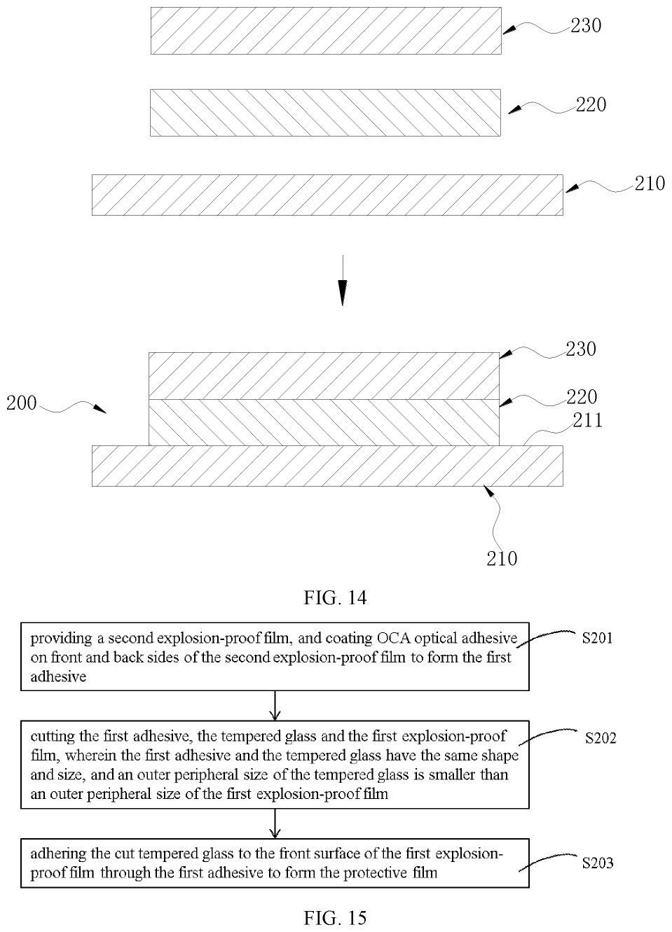

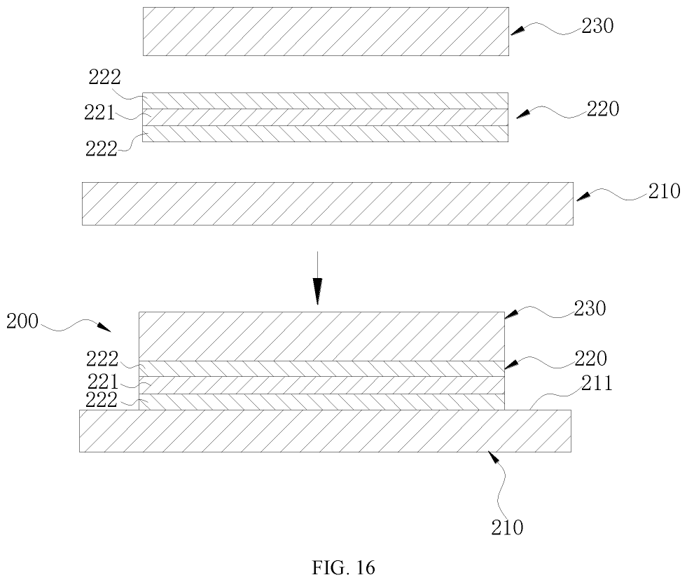

As shown in FIG. 15, preferably, in this embodiment, the first adhesive 220 includes a second explosion-proof film 221 and OCA optical adhesives 222 disposed on front and back sides of the second explosion-proof film 221, respectively. That is, the first adhesive 220 has OCA optical adhesives on both sides. Specifically, the OCA optical adhesives 222 can be coated on two sides of the second explosion-proof film 221 to form in one piece of the first adhesive 220, and the first adhesive 220 can be then attached to the first explosion-proof film 210 and the tempered glass 230 to form the protective film 200. The first adhesive 220 has the OCA optical adhesive 222 on both sides thereof, so that the adhesive strength is greater, the resulted protective film 200 is more stable, and the first explosion-proof film 210 and the tempered glass 230 on two sides of the first adhesive 220 are not easily detached. The second adhesive 300 is glue, and the adhesive strength of the second adhesive 300 is set to be greater than that of the first adhesive 220. The second explosion-proof film 221 can be, but is not limited to, a PET substrate.

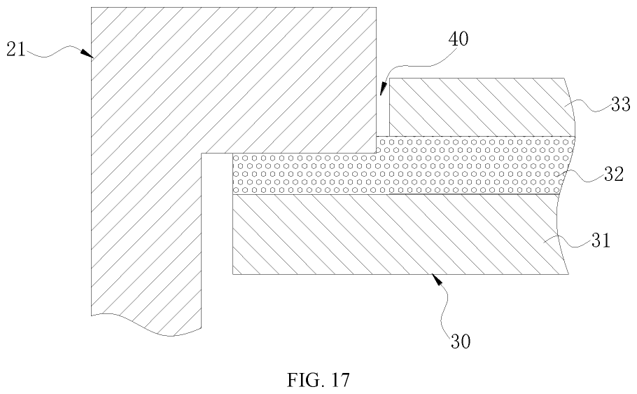

Referring to FIG. 3, FIG. 9, FIG. 15 and FIG. 16, specifically, the first adhesive 220 has OCA optical adhesives on both sides, and the step of providing the protective film 200 includes:

In step S201, a second explosion-proof film 221 is provided. The OCA optical adhesive 222 is coated on both sides of the second explosion-proof film 221 to form the first adhesive 220.

In step S202, the first adhesive 220, the tempered glass 230 and the first explosion-proof film 210 are cut into size. The first adhesive 220 and the tempered glass 230 have the same shape and size. The cross section of the first adhesive 220 is substantially rectangular, and the four corners of the first adhesive 220 can be chamfered. The outer peripheral size of the tempered glass 230 is smaller than that of the first explosion-proof film 210.

In step S203, the tempered glass 230 is adhered and fixed to the front surface of the first explosion-proof film 210 by the first adhesive 220 to form the protective film 200. The side wall of the tempered glass 230 is flush with the side wall of the first adhesive 220, and the periphery of the first explosion-proof film 210 extends beyond the peripheries of the tempered glass 230 and the first adhesive 220 to form the protruding periphery 211. In other words, the first adhesive 220, the tempered glass 230 and the first explosion-proof film 210 of the protective film 200 are separated before cutting, and after cutting, the tempered glass 230 is fixed to the first explosion-proof film 210 by the first adhesive. The protective film 200 provides the protruding periphery 211 for adhering with the flange 120, and the front surface of the protruding periphery 211 is not covered with the OCA optical adhesive 222, so that, in the resulted protective case for mobile device 1, the region of the first explosion-proof film 210 corresponding to the gap 400 between the tempered glass 230 and the flange 120 would not be adhered with dust and foreign matters, and the dust and foreign matters accumulated in the gap 400 can be easily removed.

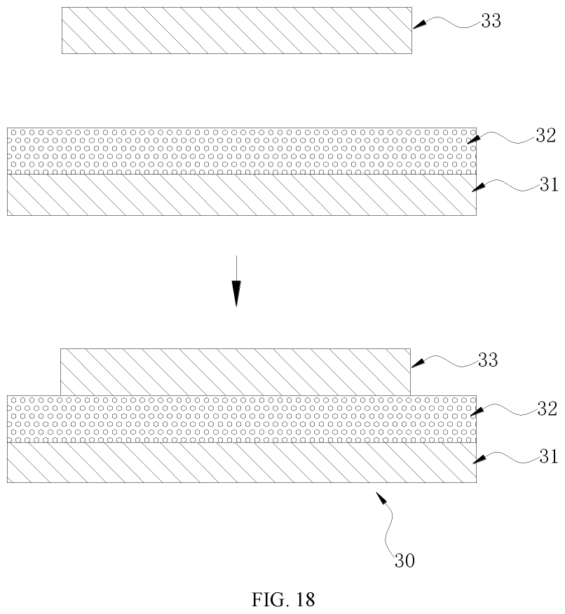

Referring to FIGS. 17 and 18, in a comparative example, the first explosion-proof film 31 and the OCA optical adhesive 32 are formed in one piece. The cut first explosion-proof film 31 and the OCA optical adhesive 32 have the same peripheral size. The outer peripheral size of the tempered glass 33 is smaller than that of the first explosion-proof film 31. After adhering the tempered glass 33 to the first explosion-proof film 31, the outer peripheries of the first explosion-proof film 31 and the OCA optical adhesive 32 extend beyond the tempered glass 33. The first explosion-proof film 31 is adhered and fixed to the protective case frame 21 by the OCA optical adhesive 32 beyond the tempered glass 33, so that the protective film 30 is fixed to the protective case frame 21. In such resulted protective case for mobile device, dust and foreign matters enter the gap 40 between the tempered glass 33 and the protective case frame 21, and are easily adhered to the OCA optical adhesive 32 on the front side of the periphery of the first explosion-proof film 210. For long-term use, the gap 40 is filled with dust and foreign matters, and the dust and foreign matters adhering to the OCA optical adhesive 32 cannot be completely cleaned, which affects the overall aesthetic appearance of the mobile device. In addition, the protective film 30 can be applied only to the protective case frame 21 made of soft plastic, and if applied to the protective case frame 21 made of hard plastic, the protective film 30 can be easily detached due to the small adhesive strength of the OCA optical adhesive 32.

Referring to FIG. 8, in this embodiment, as there is no adhesive attached to the area of the front side of the protruding periphery 211 corresponding to the gap 400 between the flange 120 and the tempered glass 230, dust and foreign matters would not be adhered to the front surface of the first explosion-proof film 210. Even if dust and foreign matters enter the gap 400 between the flange 120 and the tempered glass 230, the dust and foreign matters can be easily removed from the gap 400, facilitating the removal of the dust and foreign matters for long-term use. In addition, the second adhesive 300 having a larger adhesive strength is used to adhere the protruding periphery 211 with the flange 120, which can be applied to the protective case frame made of soft plastic or hard plastic, and the protective film 200 is stable after being fixed to the protective case frame 100 and is less likely to fall off from the protective case frame 100.

In a comparative example, the first explosion-proof film of the protective film is provided with an adhesive layer on the surface in contact with the screen of the mobile device. The protective film is directly adhered on the screen of the mobile device after the protective case for mobile device is assembled to the mobile device. When removing the protective case for mobile device, the adhesive layer of the protective film is removed from the screen so that the protective case for mobile device cannot be reused. By contrast, in this embodiment, the surface of the first explosion-proof film 210 for contacting with the screen of the mobile device is not provided with an adhesive layer, avoiding the problem that the protective case for mobile device cannot be reused due to the removal of the adhesive layer of the protective film 200 from the screen when removing the protective case for mobile device 1 from the mobile device, prolonging the service life of the protective case for mobile device 1.

Preferably, the surface of the first explosion-proof film 210 for contacting the screen of the mobile device is provided with textures, so that the attachment force between the first explosion-proof film 210 and the screen of the mobile device is reduced. The protective case for mobile device 1 can be removed easily from the mobile device. Further, when removing the protective case for mobile device 1, the first explosion-proof film 210 of the protective case for mobile device 1 would not be easily damaged, thereby further prolonging the service life of the protective case for mobile device 1.

Specifically, the first explosion-proof film 210 is made of polyethylene terephthalate (PET). Polyethylene terephthalate is also called as polyester resin, which is a kind of thermoplastic polyester, with good mechanical properties, high impact strength, oil and fat resistance and excellent physical and mechanical properties in a wide temperature range.

The protective case frame 100 can be made of soft plastic or hard plastic. That is, the protective film 200 can be applied for adhesion with the protective case frame 100 made of soft or hard plastic. Further, the protective film 200 and the protective case frame 100 can be fixed relatively stably, and the protective film 200 is not easily detached from the protective case frame 100, thereby extending the choices of the materials of the protective case frame 100.

The foregoing is merely preferred embodiments of the present application, and is not intended to limit the present application. Any modifications, equivalents, improvements, etc. made within the spirit and principles of the present application, fall in the protection scope of this application.

1. A protective case for mobile device, comprising: a bottom case and a top case which are detachably connected with each other, wherein the top case comprises:
a protective case frame comprising a side wall and a flange, the side wall enclosing an axially through receiving cavity for receiving the mobile device, the flange protruding radially inwardly from an inner wall surface of the side wall, and an inner periphery of the flange defining an opening for exposing a screen of the mobile device; and
a protective film comprising a first explosion-proof film having opposed front and back surfaces, a first adhesive provided on the front surface of the first explosion-proof film, and a tempered glass fixed to a central region of the front surface of the first explosion-proof film by the first adhesive without covering a perimeter region of the front surface, wherein the first explosion-proof film has a profile fit with a profile of the flange;
wherein the perimeter region of the front surface of the first explosion-proof film faces and is adhered to a back surface of the flange by a second adhesive, a front surface of the tempered glass distant from the first explosion-proof film faces outside through the opening enclosed by the flange, and an outer periphery of the tempered glass is radially aligned with and spaced from the inner periphery of the flange with a gap defined between them.

2. The protective case for mobile device of claim 1,
wherein the back surface of the flange is provided with a step comprising a first step surface and a second step surface connected to each other, one end of the first step surface is connected with the side wall of the protective case frame, and the step is formed so that a shielding surface is formed on the back surface of the flange, and wherein the second step surface and the shielding surface enclose an annular groove, the perimeter region of the front surface of the first explosion-proof film is fixed on the first step surface by the second adhesive, and the outer periphery of the tempered glass extends into the annular groove.

3. The protective case for mobile device of claim 2, wherein the gap is defined between the outer periphery of the tempered glass and the second step surface.

4. The protective case for mobile device of claim 2, wherein the front surface of the tempered glass abuts against the shielding surface.

5. The protective case for mobile device of claim 1, wherein a snapping structure is provided between the bottom case and the protective case frame, and the top case is snapped with the bottom case through the snapping structure.

6. A method for manufacturing the protective case for mobile device of claim 1, wherein the method comprises the following steps:
providing a protective case frame comprising a side wall and a flange extending from an inner wall surface of the side wall;
providing a protective film comprising a first explosion-proof film having opposed front and back surfaces, a first adhesive provided on the front surface of the first explosion-proof film, and a tempered glass fixed to a central region of the front surface of the first explosion-proof film by the first adhesive without covering a perimeter region of the front surface, wherein the first explosion-proof film has the profile fit with the profile of the flange;
coating a second adhesive on the perimeter region of the front surface of the first explosion-proof film;
placing the protective film within the protective case frame, and fixing the perimeter region of the front surface of the first explosion-proof film to the back surface of the flange by the second adhesive, thereby fixing the protective film to the protective case frame so as to form the top case, wherein the front surface of the tempered glass distant from the first explosion-proof film faces outside through the opening enclosed by the flange, and an outer periphery of the tempered glass is radially aligned with and spaced from the inner periphery of the flange with a gap defined between them; and
providing a bottom case, and assembling the top case to the bottom case so as to form the protective case for mobile device.

7. The method for manufacturing the protective case for mobile device of claim 6, wherein the step of coating the second adhesive on the front surface of the protruding periphery is performed by dispensing.

8-13. (canceled)

14. The method for manufacturing the protective case for mobile device of claim 6, wherein the step of providing the protective film comprises:
cutting an OCA optical adhesive, the tempered glass and the first explosion-proof film, wherein the OCA optical adhesive and the tempered glass have the same shape and size, and an outer peripheral size of the tempered glass is smaller than an outer peripheral size of the first explosion-proof film; and
fixing the cut tempered glass on the front surface of the first explosion-proof film by the OCA optical adhesive to form the protective film;
wherein a side wall of the tempered glass is flush with a side wall of the OCA optical adhesive, and the periphery of the first explosion-proof film extends beyond the peripheries of the tempered glass and the OCA optical adhesive to form the protruding periphery.

15. The method for manufacturing the protective case for mobile device of claim 6, wherein the step of providing the protective film comprises:
providing a second explosion-proof film, and coating OCA optical adhesive on front and back sides of the second explosion-proof film to form the first adhesive;
cutting the first adhesive, the tempered glass and the first explosion-proof film, wherein the first adhesive and the tempered glass have the same shape and size, and an outer peripheral size of the tempered glass is smaller than an outer peripheral size of the first explosion-proof film; and
adhering the cut tempered glass to the front surface of the first explosion-proof film through the first adhesive to form the protective film;
wherein a side wall of the tempered glass is flush with a side wall of the first adhesive, and the periphery of the first explosion-proof film extends beyond the peripheries of the tempered glass and the first adhesive so as to form the protruding periphery.

16-22. (canceled)

23. The protective case for mobile device of claim 1, wherein a space is defined between an outer periphery of the first explosion-proof film and the inner wall surface of the side wall of the protective case frame.

24. The protective case for mobile device of claim 1, wherein a material of the second adhesive is different from a material of the first adhesive.

25. The protective case for mobile device of claim 24, wherein the first adhesive is OCA optical adhesive, and the second adhesive is glue, and wherein the second adhesive has an adhesive strength greater than the first adhesive.

26. The protective case for mobile device of claim 24, wherein the first adhesive comprises a second explosion-proof film and OCA optical adhesives disposed on front and back sides of the second explosion-proof film, and the second adhesive is glue, and wherein the second adhesive has an adhesive strength greater than the first adhesive.

27. The protective case for mobile device of claim 26, wherein the second explosion-proof film is made of polyethylene terephthalate.

28. The protective case for mobile device of claim 1, wherein the back surface of the first explosion-proof film for contacting the screen of the mobile device is not provided with an adhesive layer.

29. The protective case for mobile device of claim 1, wherein the back surface of the first explosion-proof film for contacting the screen of the mobile device is provided with a texture.

30-31. (canceled)

32. The protective case for mobile device of claim 1, wherein the tempered glass is separated from the flange of the protective case frame.

33. A protective case for mobile device, comprising:
a bottom case, comprising a bottom wall for covering a back surface of the mobile device and a first side wall extending from an outer periphery of the bottom wall; and
a top case detachably connected with the bottom case, comprising:
a protective case frame comprising a second side wall and a flange, the second side wall of the protective case frame enclosing an axially through receiving cavity for receiving the mobile device, the flange protruding radially inwardly from an inner wall surface of the second side wall of the protective case frame, and an inner periphery of the flange defining an opening for exposing a screen of the mobile device; and
a protective film, comprising:
a first explosion-proof film, a front surface of which has a central region in a middle thereof and a perimeter region surrounding the central region, wherein in an assembly direction of the bottom case and the top case, the central region of the front surface is aligned with and facing the opening, and the perimeter region is aligned with and facing a back surface of the flange;
a first adhesive provided on the central region of the front surface of the first explosion-proof film;
a tempered glass fixed to the central region of the front surface of the first explosion-proof film by the first adhesive without covering the perimeter region of the front surface of the first explosion-proof film; and
a second adhesive provided on the perimeter region of the front surface of the first explosion-proof film and separated from the first adhesive;
wherein the first explosion-proof film is directly adhered to the back surface of the flange by the second adhesive.

34. The protective case for mobile device of claim 33, wherein the tempered glass is separated from the flange of the protective case frame.

35. The protective case for mobile device of claim 33, wherein a space is defined between an outer periphery of the first explosion-proof film and the inner wall surface of the second side wall of the protective case frame.
